(19) United States
(12) Patent Application Publication
(10) Pub. No.: US 2025/0124518 A1
(43) Pub. Date: Apr. 17, 2025

(54) GENERATING AN OUTPUT BASED ON PROCESSED SENSOR DATA

(71) Applicant: ALLSTATE INSURANCE COMPANY, Norhbrook, IL (US)

(72) Inventors: SHANNON M. BOWES, MUNDELEIN, IL (US); HOWARD HAYES, Glencoe, IL (US); SURENDER KUMAR, Palatine, IL (US)

(21) Appl. No.: 19/001,874

(22) Filed: Dec. 26, 2024

Related U.S. Application Data
(63) Continuation of application No. 15/255,787, filed on Sep. 2, 2016.

(51) Int. Cl. G06Q 40/08; H04M 15/00; H04W 4/24

(52) U.S. Cl. CPC G06Q 40/08; H04M 15/58; H04W 4/24

(57) ABSTRACT

Systems, methods, computer-readable media, and apparatuses for evaluating device usage and generating one or more outputs based on the device usage are provided. For instance, data from one or more sensors within a user personal mobile device may be received and processed to determine movement associated with the device. In addition, an amount of usage (e.g., hours, minutes, etc.) associated with the device may be received. In some examples information regarding the device or user of the device may be received. In some examples, application usage and/or types of applications used may also be received. This data may be processed and a likelihood of damage to the device may be determined. Based on this likelihood, one or more outputs may be determined.

### CROSS REFERENCE TO RELATED APPLICATIONS

The present application is a continuation of U.S. patent application Ser. No. 15/255,787 filed Sep. 2, 2016, entitled “GENERATING AN OUTPUT BASED ON PROCESSED SENSOR DATA”, which is incorporated by reference in its entirety herein.

### TECHNICAL FIELD

Aspects of the disclosure generally relate to one or more computer systems, servers, and or other devices including hardware and/or software. In particular, aspects are directed to evaluating device to determine a likelihood of damage to the device and generating one or more outputs based on the determined likelihood.

### BACKGROUND

Nearly everyone today uses some sort of personal mobile device on a regular basis. For instance, people use smartphones, cell phones, wearable devices such as smart watches and fitness monitors, tablets, laptops, and the like, for communication, to conduct business, to shop, to obtain information, etc. Because people use these devices so frequently and for so many different purposes, and because some users are more careful than others in using devices, it may be advantageous to protect devices against damage or protect a user from costs associated with damage. Accordingly, many users obtain insurance to protect the device, cover costs associated with damage and the like. However, conventional mobile device insurance arrangements are not customized based on usage of the device. Rather, a user who uses a cell phone to only make phone calls and otherwise keeps the device stowed away may pay a same amount as someone who uses his or her smartphone for business, email, shopping, listening to music, during exercise, and the like. Accordingly, it may be advantageous to evaluate usage of a device and determine one or more outputs, such as an insurance premium, based on the device usage and/or device user.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to methods, computer-readable media, systems, and apparatuses for evaluating device usage and generating one or more outputs based on the device usage. For instance, data from one or more sensors within a user personal mobile device may be received and processed to determine movement associated with the device. In addition, an amount of usage (e.g., hours, minutes, etc.) associated with the device may be received. In some examples, application usage and/or types of applications used may also be received. This data may be processed and a likelihood of damage to the device may be determined. Based on this likelihood, one or more outputs may be determined.

In some examples, data from various other sources may be used to determine a likelihood of damage to the user personal mobile device. For instance, the system may query a database to obtain general information about the device (e.g., make, model, materials, etc.) and this information may be used to determine a likelihood of damage. In another example, location information may be used to determine a likelihood of damage. Additionally or alternatively, data from a vehicle, such as vehicle operational data, driving behaviors, and the like, may be used to determine a likelihood of damage.

In some examples, the system may generate one or more recommendations for reducing a likelihood of damage to the device. The recommendation may be transmitted to the user personal mobile device and displayed on the device. Further, in some arrangements, the system may generate one or more incentives to implement the generated one or more recommendations. These may be transmitted to the user personal mobile device and displayed on the device.

These and other features and advantages of the disclosure will be apparent from the additional description provided herein.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates an environment including illustrative servers, computing devices, and the like, for performing various device usage analysis functions, generating recommendations, generating incentives, and the like, according to one or more aspects described herein.

FIG. 2 is a diagram illustrating various components and devices of a device usage and output determination system according to one or more aspects described herein.

FIGS. 3A-3E depict an illustrative event sequence for evaluating device usage and generating an output according to one or more aspects described herein.

FIG. 4 illustrates one example flow chart illustrating an example method of evaluating device usage to determine an output according to one or more aspects described herein.

FIG. 5 illustrates one example flow chart illustrating an example method of generating a premium for a usage-based insurance arrangement according to one or more aspects described herein.

FIG. 6 illustrates one example flow chart illustrating an example method of activating or enabling insurance on a user personal mobile device according to one or more aspects described herein.

FIG. 7 illustrates one example user interface including a usage dashboard that may be generated by one or more systems or devices according to one or more aspects described herein.

FIG. 8 illustrates one example user interface including one or more generated recommendations and one or more generated incentives according to one or more aspects described herein.

FIG. 9 illustrates a network environment and computing systems that may be used to implement aspects of the disclosure.

### DETAILED DESCRIPTION

In the following description of the various embodiments, reference is made to the accompanying drawings, which form a part hereof, and in which is shown by way of illustration, various embodiments of the disclosure that may be practiced. It is to be understood that other embodiments may be utilized.

As will be appreciated by one of skill in the art upon reading the following disclosure, various aspects described herein may be embodied as a method, a computer system, or a computer program product. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

One or more aspects described herein may be related to evaluating usage of a device to determine an output. For instance, user personal mobile device insurance is often not customized based on usage of the device. Rather, users who only occasionally use a device may be charged a same or similar price to those who use their devices often. Accordingly, the arrangements described herein monitor usage of a device (e.g., movement of the device, overall amount of usage, types of applications used, and the like) to determine a likelihood of damage to the device. This determined likelihood may then be used to generate one or more outputs, such as an insurance premium.

These and other aspects will be described more fully herein.

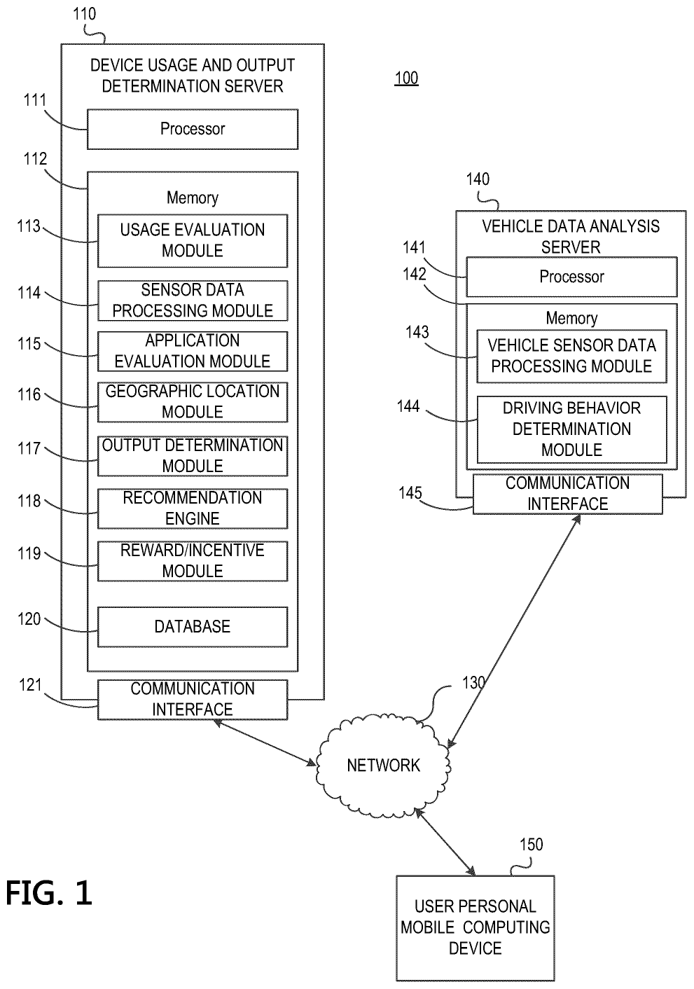

FIG. 1 depicts an environment 100 including illustrative servers, computing devices, and the like, for performing various device usage and output determination functions, including, for instance, determining an output based on received sensor and other data, generating one or more recommendations, generating one or more rewards and/or incentives, and the like, according to one or more aspects described herein. For instance, the environment 100 includes a device usage and output determination server 110, a vehicle data analysis server 140, and a user personal mobile computing device 150. The various devices, servers, and the like, may be connected or in communication with each other via a network 130. The network 130 may be a private network (e.g., a network owned and/or operated by an entity, such as an insurance provider) or may be a public network (e.g., a public network providing, in some examples, secure communication between devices).

The device usage and output determination server 110 may include may include one or more processors 111, memory 112, and communication interface 121. A data bus may interconnect processor(s) 111, memory 112, and communication interface 121. Communication interface 121 may be a network interface configured to support communication between device usage and output determination server 110 and one or more networks (e.g., network 130). Memory 112 may include one or more program modules having instructions that when executed by processor(s) 111 cause device usage and output determination server 110 to perform one or more functions described herein. In some instances, the one or more program modules and/or databases may be stored by and/or maintained in different memory units of device usage and output determination server 110 and/or by different computer systems or devices that may form and/or otherwise make up the device usage and output determination server 110. In some arrangements, different features or processes performed may be performed by different sets of instructions, such that the processor may execute each desired set of instructions to perform different functions described herein.

For example, memory 112 may include a device usage evaluation module 113. The device usage evaluation module 113 may include hardware and/or software configured to perform various functions within the device usage and output determination server 110. For instance, the device usage evaluation module 113 may monitor usage of one or more computing devices, such as user personal mobile computing device 150. Monitoring usage may include evaluating a number of minutes, hours, or the like, the device is activated in a particular time period (e.g., one day, one month, etc.). In some arrangements, monitoring usage may include determining how much time (e.g., minutes, hours, etc.) the user personal computing device 150 was engaged in a particular type of use. For instance, the device usage evaluation module 113 may determine an amount of time (e.g., minutes, hours, etc.) in a predetermined time period (e.g., one day, one month, etc.) that the device 150 was engaged in texting activities. In another example, the device usage evaluation module 113 may determine an amount of time (e.g., minutes, hours, etc.) in a predetermined time period (e.g., one day, one month, etc.) that the device 150 was engaged in talk or traditional phone call activities. In still another example, the device usage evaluation module 113 may determine an amount of time (e.g., minutes, hours, etc.) in a predetermined time period (e.g., one day, one month, etc.) that the device 150 was engaged in application related activities. In some examples, usage of different types may indicate an increased risk and, accordingly, may result in variations in the determined output, as will be discussed more fully below.

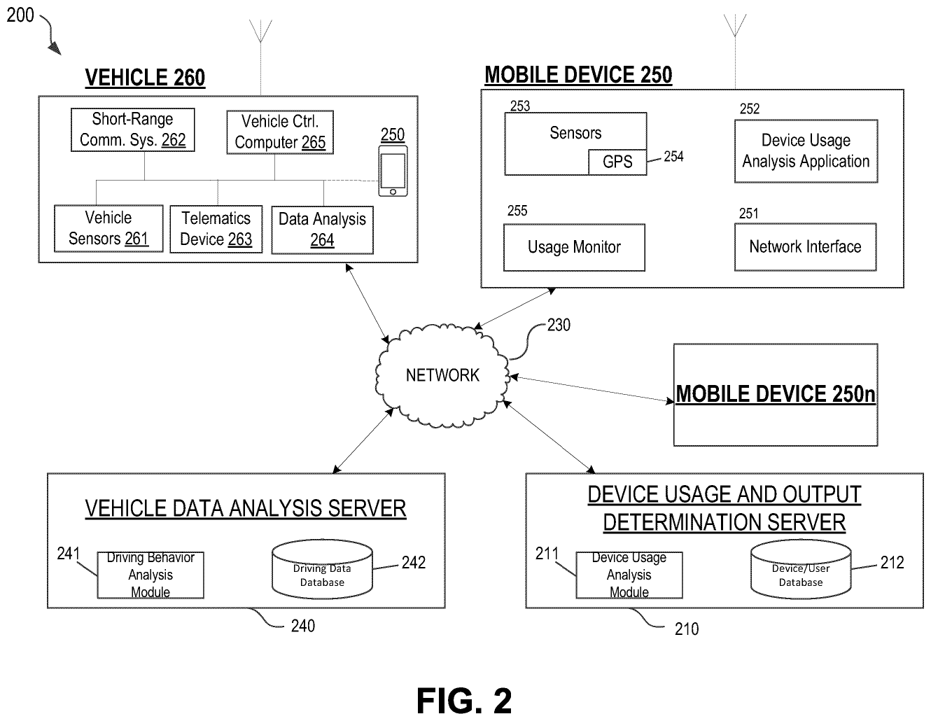

In some arrangements, usage data used to determine an amount of usage may be collected by, for instance, a device usage monitor, which may include hardware (e.g., processor, etc.) and/or software configured to monitor overall usage and types of usage of the user personal mobile computing device 150. One example device usage monitor may be discussed with respect to FIG. 2.

The device usage and output determination server 110 may further include a sensor data processing module 114. The sensor data processing module 114 may include hardware and/or software configured to perform various functions within the device usage and output determination server 110. For instance, the sensor data processing module 114 may receive raw data from one or more sensors arranged within the user personal computing device 150. Some example sensors may include accelerometers, gyroscopes, pressure sensors, proximity sensors, and the like. Signals or data collected by the sensors may be transmitted to the sensor data processing module 114 for processing. The processing of the sensor data may result in data indicating how often there was movement of the user personal computing device 150, a type of movement, conditions surrounding the device 150, and the like. This may be useful in determining a risk associated with a user's use of the user personal computing device 150.

In some examples, the data may be processed to filter data that may be considered less useful. For instance, if movement data is being collected by one or more sensors on a continuous or nearly continuous basis, the system may filter out data corresponding to times when no or little movement of the device is detected based on sensor data. For instance, in some examples, a minimum threshold amount of movement, as determined from the received data, may be necessary for the data to be processed. In such arrangements, the data associated with movement below the threshold may be removed and/or no further processing may be performed on that data. Instead, any further processing may be focused on the sensor data associated with at least the threshold amount of movement.

In some examples, processing the received raw data may include evaluating a signature of one or more signals to determine a type of movement associated with the device. For instance, the signature of the signals may be used to determine whether a user was walking with the user personal computing device 150 and/or running with the user personal computing device 150 for at least a threshold amount of time. Users who run with their user personal computing device 150 may be more likely to have a breakage issue, drop the phone, and the like, and, accordingly, may be at a higher risk for a claim. In some examples, signals within a range of 0.5 to 2.3 Hz may be indicative of walking or a slower paced activity, while signals in the range of 2.3 to 5 Hz may be indicative of running or other higher paced activity.

The sensor data processing module may, in some examples, determine, via one or more pressure sensors, proximity sensors, movement sensors, and the like, whether the user personal computing device 150 is housed within a case or other protective cover, whether a screen protector is in use, whether the device 150 is carried in a holster or is loosely carried within a purse, pocket, or the like. The sensor data processing module 114 may also determine how tightly a case fits a user personal computing device 150 to determine, for example, a quality of a case being used. Use of a device without a case, with a low quality case, without a screen protector, or the like, may increase a risk of damage to the user personal computing device 150. Accordingly, this information may be used in generating one or more outputs, as will be discussed more fully herein.

The device usage and output determination server 110 may further include an application evaluation module 115. The application evaluation module 115 may include hardware and/or software configured to perform various activities or functions within the device usage and output determination server 110. For instance, evaluating an amount of time spent interacting with applications, as well as a type of application with which a user is interacting, may be indicative of a risk associated with breakage of the phone, dropping the phone, and the like. For example, applications in which a user may spend a significant amount of time interacting (e.g., gaming applications, electronic book applications, augmented reality applications, and the like) may have a user holding, interacting with or generally using the device 150 for longer periods than other applications, such as a weather application, news application, or the like, in which a user may briefly review updated information.

Accordingly, the application evaluation module 115 may evaluate an amount of time (e.g., minutes, hours, etc.) that one or more applications are executing on the user personal computing device 150 in a predetermined time period (e.g., one day, one month, or the like). Additionally or alternatively, the application evaluation module 115 may analyze each application downloaded or otherwise provided and/or executing on the user personal computing device 150 to identify a type of application. For instance, the applications may be categorized as one of types one or two. Alternatively, three or more different types of applications may be identified. The applications may be analyzed to determine what type of application or category each application is associated with. The types of applications or categories of application may be based on an actual or expected amount of time a user may interact with each application in a particular time period, how a user interacts with a particular application (e.g., passive or active), and the like. For instance, as discussed above, applications such as gaming applications and the like with which a user may interact for extended periods may be considered a type or category one application, while applications a user may interact with less, such as news and/or weather applications may be type or category two applications. The type of category of application may be used to evaluate risk to the user personal computing device 150 and to generate one or more outputs.

The device usage and output determination server 110 may further include a geographic location module 116. The geographic location module 116 may include hardware and/or software configured to perform various functions within the device usage and output determination server 110. For instance, the geographic location module 116 may communicate with and/or connect to a global positioning system (GPS) within or associated with the user personal computing device 150 to obtain location information associated with the user personal computing device 150. In some examples, the geographic location module 116 may establish a geo-fence identifying a particular area in which a user personal computing device 150 typically is located. GPS data indicating that the user personal computing device is outside of that geo-fence may cause one or more actions to occur (e.g., insurance coverage may be activated or deactivated), as will be discussed more fully herein.

The geographic location module 116 may determine a current geographic location of the user personal computing device 150 and may evaluate a risk associated with the current location. For instance, if it is determined that the user personal computing device 150 is near water (e.g., ocean, lake, pond, etc.) or on a beach, the risk of loss or breakage of the phone may be higher. GPS data indicating that the user personal computing device 150 is at or near these types of locations above a threshold amount of time may impact one or more generated outputs, as will be discussed more fully herein. In another example, the GPS location data may indicate whether a user is in an urban, suburban or rural location. This information may also be used to determine a likelihood of damage to the device 150.

The device usage and output determination server 110 may further include an output determination module 117. The output determination module 117 may include hardware and/or software configured to perform various functions within the device usage and output determination server 110. For instance, the output determination module 117 may receive data from one or more other modules, such as usage evaluation module 113, sensor data processing module 114, application evaluation module 115, and/or geographic location module 116 and may evaluate the received data to determine a risk associated with the user personal computing device 150 and/or a likelihood that damage may occur to the device 150. Based on the evaluated data and/or the determined risk/likelihood of damage, the output determination module 117 may identify a premium or rate, such as an insurance premium or rate, for insuring the device. Accordingly, the premium or rate may be based on how often the device 150 is used, what types of applications are executed on the device 150, a type or amount of movement associated with the device 150, and the like.

In some examples, additional information such as an age of a user, a gender of a user, a credit history of a user, and the like, may also be used in determining the premium and/or rate for damage and/or loss protection coverage of the device 150. For instance users in a certain age group or of a certain gender may be known to be more prone to damage or loss of a device than in other age groups or other genders. For instance, this additional information may be retrieved from one or more databases, such as database 120, and may be used to evaluate risk associated with use of the user personal computing device 150. Further, general information about the device (e.g., make, model, age, materials used in the device, value of the device, device testing results, etc.) may also be retrieved (e.g., from one or more databases) and used to evaluate a likelihood of damage to the device 150.

In some example arrangements, a user's driving behaviors may also be used to evaluate risk associated with the user personal computing device 150. For instance, data associated with driving behaviors may be received from a vehicle data analysis server 140. The vehicle data analysis server 140 may include may include one or more processors 141, memory 142, and communication interface 145. A data bus may interconnect processor(s) 141, memory 142, and communication interface 145. Communication interface 145 may be a network interface configured to support communication between the vehicle data analysis server 140 and one or more networks (e.g., network 130). Memory 142 may include one or more program modules having instructions that when executed by processor(s) 141 cause vehicle data analysis server 140 to perform one or more functions described herein. In some instances, the one or more program modules and/or databases may be stored by and/or maintained in different memory units of vehicle data analysis server 140 and/or by different computer systems or devices that may form and/or otherwise make up the vehicle data analysis server 140. In some arrangements, different features or processes performed may be performed by different sets of instructions, such that the processor may execute each desired set of instructions to perform different functions described herein.

For example, memory 142 may include a vehicle sensor data processing module 143. The vehicle sensor data processing module 143 may include hardware and/or software configured to perform various functions within the vehicle data analysis server 140. For instance, the vehicle sensor data processing module 143 may receive data from one or more sensors associated with the vehicle. The one or more sensor may detect acceleration, braking, swerving, lane changes, and the like. Raw data from these sensors may be received by the vehicle sensor data processing module 143 and may be processed.

The processed data may be transmitted to a driving behavior determination module 144. The driving behavior determination module 144 may include hardware and/or software configured to perform various functions within the vehicle data analysis server 140. For instance, the driving behavior determination module 144 may receive the processed data and evaluate the data to determine one or more driving behaviors of the user. For instance, the driving behavior determination module 144 may evaluate the data to determine how quickly a user accelerates from a stopped position, whether the user is generally a hard braker (e.g., a number of hard braking occurrences in a time period is over a threshold), how often the user changes lanes (e.g., in a trip, a day, or the like), whether the user maintains his or her lane, and the like. This information may then be used to evaluate a risk associated with the driving behaviors of the user. For instance, each type of behavior may, in some examples, be given a score. Each score for each driving behavior (e.g., acceleration, braking, swerving, lane changes, etc.) may then be summed to determine an overall score for the user. This overall score, any of the individual scores, and/or the driving data itself may be transmitted to the output determination module 117 to determine a risk or likelihood of damage associated with the user personal mobile computing device 150 and/or an insurance rate or premium for the device 150.

The device usage and output determination server 110 may further include a recommendation engine 118. The recommendation engine 118 may include hardware and/or software configured to perform various functions within the device usage and output determination server 110. For instance, the recommendation engine 118 may evaluate data from various sources (e.g., usage evaluation module 113, sensor data processing module 114, application evaluation module 115, geographic location module 116, vehicle data analysis server 110, etc.) and may generate one or more recommendations for the user to reduce a risk of damage to the user personal mobile computing device 150. For instance, if it is detected that the user personal computing device 150 is not housed within a case, the recommendation engine may generate a recommendation to use a case with the device 150. In another example, if it is detected that the user is often using his or her user personal computing device 150 near water (e.g., at a beach, on a lake, etc.) a recommendation may be generated to limit an amount of time the device 150 is used in those areas.

In addition to generating a recommendation, a reward/incentive module 119 of the device usage and output determination server 110 may generate one or more rewards or incentives to offer to a user to implement one or more generated recommendations. For instance, the reward/incentive module 119 may offer a discount on a premium or rate for a next term if one or more recommendations are implemented. In another example, the reward/incentive module 119 may offer a refund of a portion of a premium if one or more recommendations are implemented.

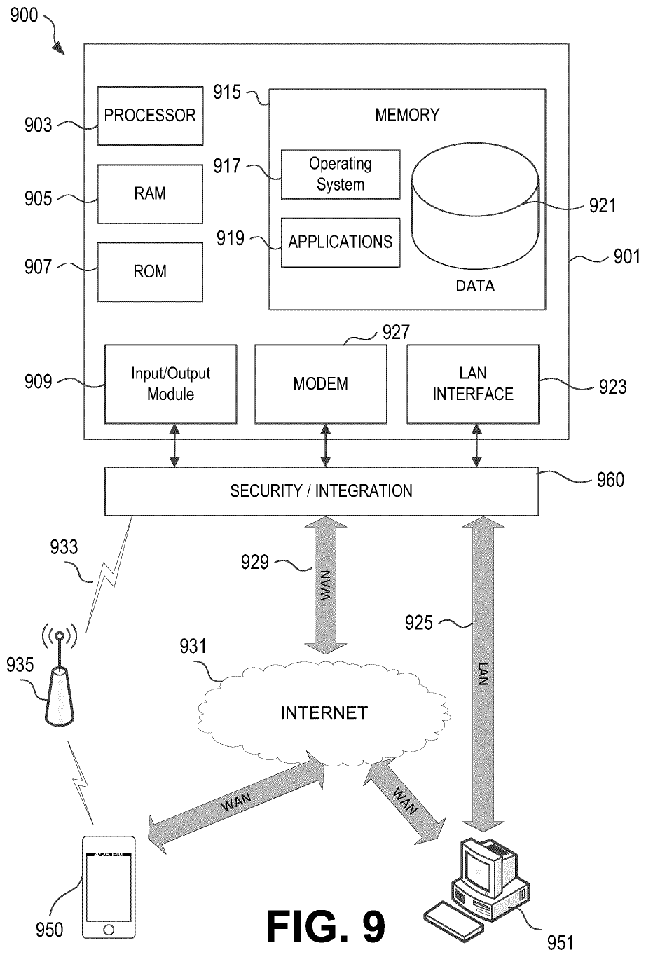

FIG. 2 is a diagram of an illustrative device usage and output determination system 200 including a vehicle 260, a mobile device 250, a vehicle data analysis server 240, a device usage and output determination server 210, and additional related components. Each component shown in FIG. 2 may be implemented in hardware, software, or a combination of the two. Additionally, each component of the device usage and output determination system 200 may include a computing device (or system) having some or all of the structural components described herein for computing device 901 in FIG. 9. The device usage and output determination system 200 may also include or be in communication with one or more servers, devices, and the like, shown and described with respect to FIG. 1.

One or more components shown in FIG. 2, such as the vehicle 260 and the user personal mobile device 250 may communicate with each other via wireless networks or wired connections (e.g., for devices physically docked in vehicles), and each may communicate with one or more additional vehicles 210a-210c, additional mobile computing devices, and/or a number of external computer servers 210, 240, over one or more communication networks 230. In some examples, the user personal mobile computing device 150 may be paired (e.g., via Bluetooth™M technology) to one or more other devices (e.g., another user personal mobile computing device, such as a wearable device, tablet, etc.). If the device is no longer in proximity to be paired (e.g., one user personal mobile computing device 150 is no longer near enough to another user personal mobile computing device to be paired) a notification may be generated and displayed on the device 150 (e.g., to indicate that you may have left a device behind).

As discussed herein, the components of device usage and output determination system 200, operating individually or using communication and collaborative interaction, may perform such features and functions such as evaluating overall usage of a device, evaluating applications executing on a device, evaluating sensor data from the device, receiving and analyzing sensor data from a vehicle, determining an output, such as an insurance premium, generating one or more recommendations and/or incentives for a user, and the like.

Device usage and output determination system 200 may include one or more user personal mobile devices 250. Mobile device 250 may be, for example, smartphones or other mobile phones, personal digital assistants (PDAs), tablet computers, laptop computers, wearable devices such as smart watches and fitness monitors, and the like. User personal mobile device 250 may include some or all of the elements described herein with respect to the computing device 901.

As discussed herein, user personal mobile devices 250 are often prone to damage or breakage due to accidents, misuse, or the like. Accordingly, insuring the user personal mobile device 250 is one way to protect against costs associated with the potential damage or breakage. However, conventional mobile device insurance plans can be expensive and might not be customizable based on amount of usage, type of usage, and the like. Accordingly, by monitoring usage of a device, the arrangements described herein may customize an insurance plan for a user personal mobile device 250 based on a variety of factors associated with the particular device. For instance, some factors that may be used to determine a likelihood of damage to the device and/or loss of the device (and, thus, an insurance premium) may include: age of the user, gender of the user, credit score or history of the user, vehicle driving data and/or behaviors of the user, vehicle insurance claim data of the user, motion of movement of the device, location information (e.g., particular location information, area or region information (e.g., based on zip code), type of area (e.g., urban, suburban, rural) and the like), usage behaviors (e.g., number of text messages sent/received, type of applications executing on the device, number of applications executing on the device), proximity to water or beach, use of device while on mass transit (e.g., based on movement sensor data, location data, speed data, etc.), whether a protective case is in use, number of hours in movement, WiFi usage, type of WiFi, purchase history, time of day device is in use, weather conditions, types of charging cords used, battery life, connectivity to other devices (e.g., how often and/or how many other devices connect to device 150, are controlled by device 150, etc.), time of day in which the device is used (e.g., devices used late at night or early in the morning, on weekends, etc. may have an increased likelihood of damage as opposed to devices used during, for instance, normal business hours), and the like. Various other factors may be considered without departing from the invention.

The user personal mobile device 250 may include a network interface 251, which may include various network interface hardware (e.g., adapters, modems, wireless transceivers, etc.) and software components to enable mobile device 250 to communicate with device usage and output determination server 210, vehicle data analysis server 240, vehicle 260, and various other external computing devices. One or more specialized software applications, such as device usage analysis applications 252 may be stored in the memory of the mobile device 250. The device usage analysis application(s) 252 may be received via network interface 251 from the device usage and output determination server 210, vehicle 260, or other application providers (e.g., public or private application stores). Certain device usage analysis applications 252 might not include user interface screens while other applications 252 may include user interface screens that support user interaction Such applications 252 and may be configured to run as user-initiated applications or as background applications. The memory of mobile device 250 also may include databases configured to receive and store sensor data received from mobile device sensors, usage type, application usage data, and the like. Although aspects of the device usage analysis software application(s) 252 are described as executing on mobile device 250, in various other implementations, some or all of the device usage analysis functionality described herein may be implemented by device usage and evaluation server 210.

As discussed herein, mobile device 250 may include various components configured to generate and/or receive data associated with usage of the user personal mobile device 250, movement of the user personal mobile device 250, location of the user personal mobile device 250, and the like. For example, using data from sensors 253 (e.g., 1-axis, 2-axis, or 3-axis accelerometers, compasses, speedometers, vibration sensors, gyroscopic sensors, etc.) and/or GPS receivers or other location-based services (LBS) 254, an application 252 (or other device or module, e.g., device usage and output determination server 210) may determine movement of the mobile device 250 (e.g., in a vehicle, with a user who is walking, with a user who is running, etc.). The sensors 253 and/or GPS receiver or LBS component 254 of a mobile device 250 may also be used to determine driving speeds, routes, accident force and angle of impact, and other accident characteristics and accident-related data.

User personal mobile device 250 may further include a usage monitor 255. The usage monitor may be a device (e.g., including a processor, etc.) and may include hardware and/or software configured to monitor various aspects of the usage of the mobile device 250. For instance, the usage monitor 255 may monitor a number of minutes, hours, or the like the device is in use (e.g., based on factors such as device being illuminated, user interacting with or looking at the device, etc.). Further, the usage monitor 255 may monitor which applications are used above a threshold amount of time in a predetermined time period (e.g., one day, one week, one month, or the like). In still other examples, the usage monitor 255 may determine a type of motion or speed of motion associated with movement of the mobile device 250, whether the device is maintained within a case, and the like. Additional aspects of device usage may be monitored without departing from the invention. In some examples, data from usage monitor 255 may be accessed by the device usage analysis application 252 for analysis and/or transmission to, for instance, device usage and output determination server 210. Additionally or alternatively, data from usage monitor 255 may be transmitted directly to the device usage and output determination server 210.

The user personal mobile device 250 may be configured to establish communication with device usage and output determination server 210 via one or more wireless networks (e.g., network 23). Additionally or alternatively, the user personal mobile device, when carried in a vehicle, may be used to detect performance and/or operational characteristics of the vehicle 260, similar to the one or more sensors arranged in the vehicle 260.

As discussed above, user personal mobile device 250 may be configured to be paired (e.g., via Bluetooth™ technology) to one or more other devices, such as vehicle 260, other mobile device 250n, or the like. Other mobile device 250n may include one or more other mobile devices having some or all of the components, functionality, and the like, of user personal mobile computing device 250. In some examples, device usage analysis application 252 may monitor a status of the devices (e.g., whether the devices 250, 250n are paired, no longer paired, etc.) and, upon determining that the devices are no longer paired (e.g., that one of mobile devices 250, 250n is no longer within range of other mobile device 250, 250n) a notification may be generated and transmitted to one or both mobile devices 250, 250n. Accordingly, if one device is inadvertently left somewhere (e.g., at a store, on a bus or train, etc.) the user may be notified as soon as the devices are no longer paired, thereby increasing the chance of recovering the lost device.

Device usage and output determination system 200 may further include a vehicle 260. Vehicle 260 may be, for example, automobiles, motorcycles, scooters, buses, recreational vehicles, boats, or any other vehicles for which driving behaviors may be analyzed. Vehicle 210 may include vehicle operation sensors 261 capable of detecting and recording various conditions at the vehicle and operational parameters of the vehicle. For example, sensors 261 may detect and store data corresponding to the vehicle's location (e.g., GPS coordinates), time, travel time, speed and direction, rates of acceleration or braking, gas mileage, and specific instances of sudden acceleration, braking, swerving, and distance traveled. Sensors 261 also may detect and store data received from the vehicle's 260 internal systems, such as impact to the body of the vehicle, air bag deployment, headlights usage, brake light operation, door opening and closing, door locking and unlocking, cruise control usage, hazard lights usage, windshield wiper usage, horn usage, turn signal usage, seat belt usage, phone and radio usage within the vehicle, autonomous driving system usage, maintenance performed on the vehicle, and other data collected by the vehicle's computer systems, including the vehicle on-board computing device (OBD).

Additional sensors 261 may detect and store the external driving conditions, for example, external temperature, rain, snow, light levels, and sun position for driver visibility. For example, external cameras and proximity sensors 261 may detect other nearby vehicles, vehicle spacing, traffic levels, road conditions, traffic obstructions, animals, cyclists, pedestrians, and other conditions that may relate to vehicle accidents and accident characteristics. Sensors 261 also may detect and store data relating to moving violations and the observance of traffic signals and signs by the vehicle 260. Additional sensors 261 may detect and store data relating to the maintenance of the vehicle 260, such as the engine status, oil level, engine coolant temperature, odometer reading, the level of fuel in the fuel tank, engine revolutions per minute (RPMs), software upgrades, and/or tire pressure.

Vehicles sensors 261 also may include cameras and/or proximity sensors capable of recording conditions inside or outside of the vehicle 260. For example, internal cameras may detect conditions such as the identity of the driver (e.g., using facial recognition software), the number of the occupants, the types of occupants (e.g. adults, children, teenagers, pets, etc.), and the seating/positioning of the occupants in the vehicles. Internal cameras also may detect potential sources of driver distraction within the vehicle, such as pets, phone usage, and unsecured objects in the vehicle. Sensors 261 also may be configured to collect data identifying a current driver from among a number of different possible drivers, for example, based on driver's seat and mirror positioning, driving times and routes, radio usage, etc. Sensors 261 also may be configured to collect data relating to a driver's movements or the condition of a driver. For example, vehicle 260 may include sensors that monitor a driver's movements, such as the driver's eye position and/or head position, etc. Additional sensors 261 may collect data regarding the physical or mental state of the driver, such as fatigue or intoxication. The condition of the driver may be determined through the movements of the driver or through other sensors, for example, sensors that detect the content of alcohol in the air or blood alcohol content of the driver, such as a breathalyzer.

Certain vehicle sensors 261 also may collect information regarding the vehicle's location, current and past driving routes, in order to classify the type of trip (e.g. work or school commute, shopping or recreational trip, unknown new route, etc.). In certain embodiments, sensors and/or cameras 261 may determine when and how often the vehicle 260 stays in a single lane or stray into other lanes. A Global Positioning System (GPS), locational sensors positioned inside the vehicle 260, and/or locational sensors or devices external to the vehicle 260 may be used to determine the route, lane position, road-type (e.g. highway, entrance/exit ramp, residential area, etc.) and other vehicle position/location data which may be used to analyze accidents and accident characteristics.

The data collected by vehicle sensors 261 may be stored and analyzed within the respective vehicle 260, for example, in vehicle data analysis device 264, which may be integrated into or installed at the vehicle 210. In other cases, the data collected by vehicle sensors 261 may be transmitted to one or more external devices for analysis, such as a user personal mobile device 250 or external servers 240, 210. Additionally, as shown in FIG. 2, sensor data from one vehicle 260 may be transmitted via a short-range communication systems 262 to other nearby vehicles, devices, and the like, and vice versa. The sensor data also may be transmitted from vehicles 260 via a telematics device 263 or other network interface(s) to one or more remote computing devices, such as one or more user personal mobile devices 250, vehicle data analysis server 240, device usage and output determination server 210, and/or other external servers.

Short-range communication systems 262 may be vehicle-based data transmission systems configured to transmit various (e.g., driving data, vehicle data, insurance data, driver and passenger data, etc.) to other nearby vehicles, and to receive corresponding data from other nearby vehicles. In some examples, communication systems 262 may use the dedicated short-range communications (DSRC) protocols and standards to perform wireless communications between vehicles. In the United States, 75 MHz in the 5.850-5.925 GHz band have been allocated for DSRC systems and applications, and various other DSRC allocations have been defined in other countries and jurisdictions. However, short-range communication systems 262 need not use DSRC, and may be implemented using other short-range wireless protocols in other examples, such as WLAN communication protocols (e.g., IEEE 802.11), Bluetooth (e.g., IEEE 802.15.1), or one or more of the Communication Access for Land Mobiles (CALM) wireless communication protocols and air interfaces. The vehicle-to-vehicle (V2V) transmissions between the short-range communication systems 212 may be sent via DSRC, Bluetooth, satellite, GSM infrared, IEEE 802.11, WiMAX, RFID, and/or any suitable wireless communication media, standards, and protocols. In certain systems, short-range communication systems 262 may include specialized hardware installed in vehicle 260 (e.g., transceivers, antennas, etc.), while in other examples the communication systems 262 may be implemented using existing vehicle hardware components (e.g., radio and satellite equipment, navigation computers) or may be implemented by software running on the mobile device 250 of drivers and/or passengers within the vehicle 260.

V2V communications also may include vehicle-to-infrastructure (V2I) communications, such as transmissions from vehicles to non-vehicle receiving devices, for example, toll booths, rail road crossings, and road-side traffic monitoring devices. Certain V2V communication systems may periodically broadcast data from a vehicle 260 to any other vehicle, or other infrastructure device capable of receiving the communication, within the range of the vehicle's transmission capabilities. The range of V2V communications and V2I communications may depend on the wireless communication standards and protocols used, the transmission/reception hardware (e.g., transceivers, power sources, antennas), and other factors. Short-range V2V (and V21) communications may range from just a few feet to many miles, and different types of vehicle data and characteristics or behaviors may be determined depending on the range of the V2V communications.

When vehicle performance or operational data, or any other data is transmitted by vehicle 260, the transmission may depend on the protocols and standards used for the V2V and V2I communication, the range of communications, and other factors. In certain examples, vehicle 260 may periodically broadcast corresponding sets of similar vehicle data, such as the vehicle's location (which may include an absolute location in GPS coordinates or other coordinate systems, and/or a relative location with respect to another vehicle or a fixed point), speed, and direction of travel. In certain examples, the nodes in a V2V communication system (e.g., vehicles and other reception devices) may use internal clocks with synchronized time signals, and may send transmission times within V2V communications, so that the receiver may calculate its distance from the transmitting node based on the difference between the transmission time and the reception time. The state or usage of the vehicle's 260 controls and instruments may also be transmitted, for example, whether the vehicle is accelerating, braking, turning, and by how much, and/or which of the vehicle's instruments are currently activated by the driver (e.g., head lights, turn signals, hazard lights, cruise control, 4-wheel drive, traction control, etc.). Vehicle warnings such as detection by the vehicle's 260 internal systems that the vehicle is skidding, that an impact has occurred, or that the vehicle's airbags have been deployed, also may be transmitted in V2V communications.

As shown in FIG. 2, vehicle 260 may use telematics devices 263 to transmit data to and receive data from servers 210, 240, and mobile devices 250. Telematics devices 263 may be computing devices containing many or all of the hardware/software components as the computing device 901 depicted in FIG. 9. In some cases, telematics devices 263 may receive vehicle sensor data, operation data, and driving data from vehicle sensors 261, and may transmit the data to one or more external computer systems (e.g., device usage and output determination server 210, vehicle data analysis server 240, or the like) over a wireless transmission network 230. The telematics devices 263 also may store the type of their respective vehicle 260, for example, the make, model, trim (or sub-model), year, and/or engine specifications, as well as other information such as vehicle owner or driver information, insurance information, warranty information, and financing information for the vehicle 260.

In the example shown in FIG. 2, telematics devices 263 may receive data from vehicle sensors 261, and may transmit the data to a mobile device 250 or vehicle data analysis server 240. However, in other examples, one or more of the vehicle sensors 261 or other vehicle-based systems may be configured to receive and transmit data directly from or to other servers 210, 240 or mobile device 250 without using a telematics device. For instance, telematics devices 263 may be configured to receive and transmit data from certain vehicle sensors 261 or systems, while other sensors or systems may be configured to directly receive and/or transmit data to servers 221, 240 or mobile device 250 without using the telematics device 263. Thus, telematics devices 263 may be optional in certain embodiments.

The system 200 also may include one or more external servers, such as device usage and output determination server 210 and vehicle data analysis server 240, each of which may contain some or all of the hardware/software components as the computing device 901 depicted in FIG. 9. Device usage and output determination server 210 and vehicle data analysis server 240 may communicate with vehicle 260 and mobile devices 250 via one or more communication networks 230.

The device usage and output determination server 210 may include some or all of the components and/or functionality described with respect to FIG. 1. The server 210 may include one or more databases 212 configured to store data associated with a user, device, or the like, that may be used to evaluate risk. Further, the server 210 may include device usage analysis module 211 which may provide some or all of the operations and/or functionality described with respect to FIG. 1.

The vehicle data analysis server 240 may include some or all of the components and/or functionality described with respect to FIG. 1. The server 240 may include one or more databases 242 configured to store data associated with driving behaviors, performance data, operational data, and the like. Further, the server 240 may include driving behavior analysis module 241 which may provide some or all of the operations and/or functionality described with respect to FIG. 1.

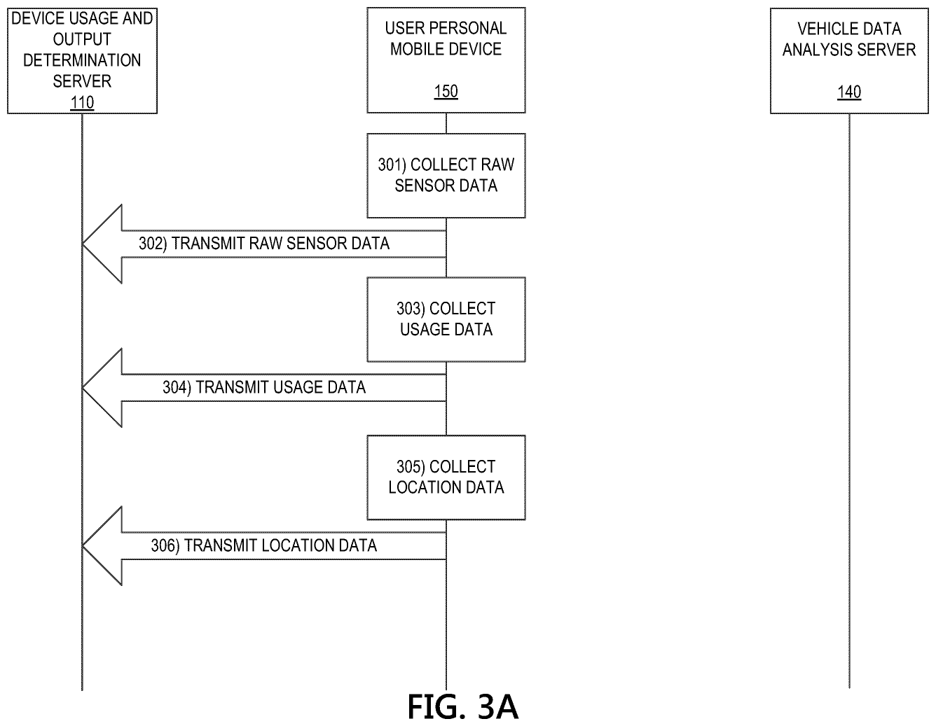

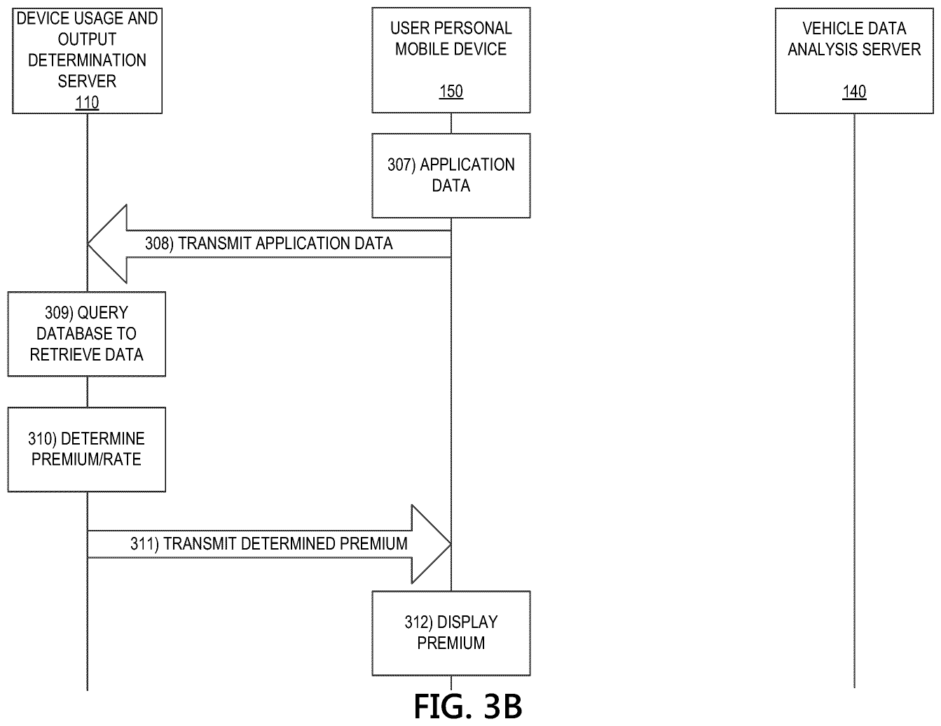

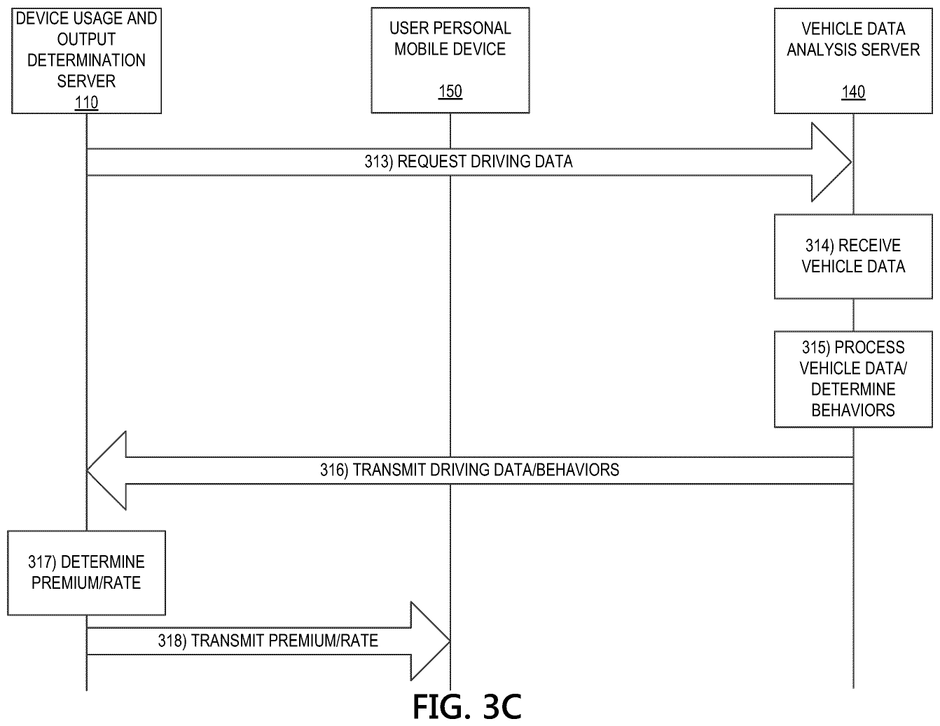

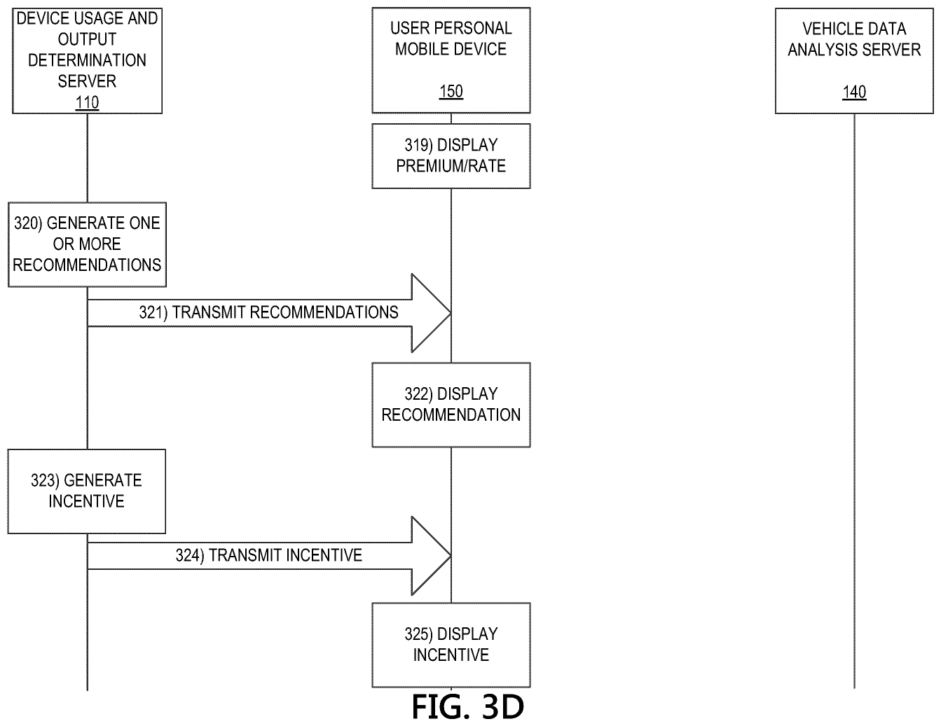

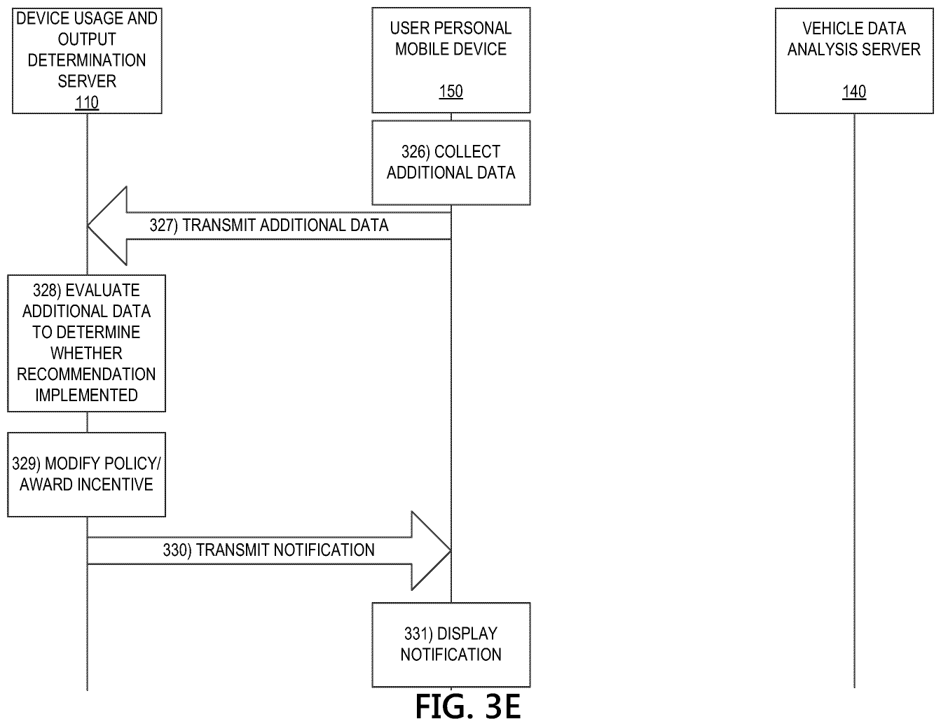

FIGS. 3A-3E illustrate one example event sequence for evaluating device usage and determining an output in accordance with one or more aspects described herein. The sequence illustrated in FIGS. 3A-3E is merely one example sequence and various other events may be included, or events shown may be omitted, without departing from the invention.

With reference to FIG. 3A, in step 301, raw sensor data may be collected by a user personal mobile computing device 150. As discussed herein, the raw sensor data may be directed to movement of the device, protective devices surrounding the user personal mobile device 150, and the like. The raw sensor data may be transmitted to, for instance, the device usage and output determination server 110 in step 302.

In step 303, usage data associated with the user personal mobile device 150 may be collected. In some examples, the usage data may be collected by a usage monitoring device 255 in the user personal mobile computing device 150. The usage data may include a number of hours, minutes, or the like that the device 150 is considered in-use within a certain time period (e.g., one day, one week, one month, etc.). In some examples, a device may be considered in-use when the screen is illuminated, when a user is viewing a screen (e.g., based on visual detection), when a user is interacting with a touchscreen, microphone, application, or the like. Usage of a user personal mobile device may include use of the device 150 as a telephone, for texting or other messaging operations, to view email, to interact with one or more other applications executing on the device, and the like. In step 304, usage information may be transmitted to the device usage and output determination server 110.

In step 305, location data may be collect by the user personal mobile device 110. The location data may include an amount of time a user spends within a predefined proximity of a designated or determined “home” location, “work” location, or the like. The location data may also include information related to a current location of the user. The current location information may be based on GPS data, geo-tagged location information associated with a captured image or the like, etc. In step 306, location information may be transmitted to the device usage and output determination server 110.

With reference to FIG. 3B, in step 307, application data may be collected by the user personal mobile device 150. In some examples, application data may be collected from a usage monitoring device 255 in user personal mobile computing device 150. For instance, data related to what applications are used, how often and/or for how long, and a type of application. In some examples, the data may be related to an amount of usage (e.g., hours, minutes, etc.) of use for each application within a predefined time period (e.g., one week, one month, or the like). In step 308, the data may be transmitted to the device usage and output determination server 110.

In step 309, the device usage and output determination server 110 may query a database to obtain additional information related to the user personal mobile device 150, a user associated with the device 150, or the like. In some examples, the information may be provided by the user (e.g., during a registration process) and stored in a database, such as database 120. The device usage and output determination server 110 may then query the database to retrieve information such as a type of device, manufacturer of the device, model of the device, age of the device, name and/or contact information of user associated with the device, age of the user, gender of the user, and the like.

In some examples, the device usage and output determination server 110 may query a plurality of databases to obtain information. Additionally or alternatively, some information retrieved from the one or more databases may be information associated with devices in general, rather than a particular device 150 for which an output is being determined. For instance, information such as claims history associated with damage to various device models, materials used in the manufacture of the device, and the like, may be retrieved for use by the server 110.

In step 310, an output may be determined. For instance, the received data may be analyzed by the device usage and output determination server and an output, such as an insurance premium or rate may be determined. The insurance premium may be for a particular term (e.g., six months, one year, etc.). In other examples, the insurance may be a usage-based type of policy in which a user may purchase insurance and funds (or other credits) may be stored in an account. As the device is used (e.g., by actual use minutes, hours, or the like or per day) a balance of the account may be reduced by a predetermined amount.

In some examples, the premium or rate may be determined by calculating a risk score or likelihood of damage associated with each factor being considered. For instance, a score associated with a level of risk of potential damage to the user personal mobile device 150 may be determined for each of raw sensor data, usage data, location data, and/or application data. Additionally or alternatively, a risk score may be determined for data retrieved from one or more databases. The scores for each factor may then be summed to determine an overall score. The overall score may be compared to one or more premium thresholds to determine an appropriate premium or rate to off to insure the user personal mobile device 150. Although the arrangement shown includes raw sensor data, usage data, location data and application data, more or fewer factors may be used without departing from the invention.

In step 311, the determined premium may be transmitted to the user personal mobile device 150 and, in step 312, the device usage and output determination server 110 may cause the determined premium to be displayed on the user personal mobile device 150 (e.g., a signal or instruction to display the premium may be transmitted to the mobile device 150, thereby causing the determined premium to be displayed).

As discussed above, in some examples, driving data or behaviors associated with the user may be used as a factor in determining an insurance premium or rate. With reference to FIG. 3C, in step 313, a request for driving data and/or behaviors may be transmitted to the vehicle data analysis server 140. In step 314, vehicle data, such as operational data, performance data, and the like, may be collected by one or more sensors within a vehicle associated with the user associated with the user personal mobile device 150.

In step 315, the received data may be processed to evaluate the data and/or identify one or more driving behaviors associated with the user. For instance, processing the data may determine whether at least a threshold number of hard braking occurrences have taken place within a predefined time period (e.g., one week, one month, etc.). In another example, the data may be processed to determine a typical rate of acceleration for a user, whether the user is able to maintain his or her lane while driving, headlight usage, and the like.

In step 316, the data and/or determined driving behaviors may be transmitted to the device usage and output determination server 110. In step 317, the received vehicle data may be aggregated with data previously received (e.g., associated with device usage, location, etc.) and an output may be determined. The output may include an insurance premium or rate to insure the user personal mobile device 150 and may be based on device and vehicle data. In some examples, the received vehicle/driving behavior data may be given a risk score. This risk score may then be summed with previously determined risk scores for other factors to obtain an overall score. The overall score may then be compared to one or more premium thresholds to determine the premium in step 317.

In step 318, the determined premium/rate may be transmitted to the user personal mobile device 150. With reference to FIG. 3D, in step 319, the device usage and output determination server 110 may cause the determined premium to be displayed on the user personal mobile device 150.

In step 320, one or more recommendations may be generated by the device usage and output determination server 110. For instance, based on the received and analyzed data (e.g., usage data, application data, location data, vehicle data, etc.) the server 110 may generate one or more recommendations for modifications to usage of the device which may reduce the risk of damage. For instance, if the received and analyzed data indicates that the device 150 is often used without a protective case, the system may generate a recommendation to use a protective case. In another example, if the received data indicates that the user is often near water (e.g., near a beach, on a lake, on a boat, or the like) the server 110 may generate a recommendation to avoid use of the device when within a certain proximity of water or to obtain a waterproof case.

In another example, if the received an analyzed data indicates that the user often exercises with the device 150, a recommendation may be made to obtain an armband to house the device 150 during workouts.

Various other recommendations may be generated without departing from the invention.

In step 321, the generated recommendation(s) may be transmitted to the user personal mobile device 150. In step 322, the device usage and output determination server 110 may cause the generated recommendation(s) to be displayed on the user personal mobile device 150 (e.g., on a display of the device).

In step 323, the device usage and output determination server 110 may generate one or more incentives to implement the generated recommendation(s). For instance, the server 110 may generate an insurance incentive in the form of a reduced premium for a next term if one or more of the recommendations are implemented. In another example, the server 110 may generate an incentive in the form of a refund of a portion of a premium paid if one or more recommendations are implemented.

In step 324, the incentive may be transmitted to the user personal mobile device 150 and, in step 325, the device usage and output determination server 110 may cause the incentive to be displayed on the device 325 (e.g., on a display of the device 150).

In some examples, the device usage and output determination server 110 may continuously monitor data associated with the device 150 and/or a vehicle. For instance, the server 110 may receive additional data from the various sources described herein on a continuous basis (e.g., in real-time or in batch transfer processes). With reference to FIG. 3E, in step 326, additional data may be collected by the user personal mobile device 150. Data collected may be similar to other types of data collected and described herein and may include usage data, application data, location data, and the like. In step 327, the additional data may be transmitted to the device usage and output determination server 110. The data may, in some examples, be analyzed to determine whether one or more recommendations have been implemented in order for the user to receive the one or more incentives.

In step 327, the received additional data may be analyzed to determine whether one or more recommendations have been implemented. For instance, if one recommendation was to carry the device 150 in a protective case and the sensor data (e.g., pressure sensor, proximity sensor, etc.) indicates that the device is in a case, the server 110 may determine that the recommendation was implemented and may award the user with the generated incentive (e.g., deposit funds in an account, reduce a premium amount for renewal, etc.). In step 329, the policy may be modified (e.g., a premium reduced, etc.) and/or an incentive may be rewarded (e.g., funds deposited in an account, etc.) based on the detected recommendation being implemented.

In step 330, a notification of the policy modification and/or incentive being awarded may be generated and transmitted to the user personal mobile device 150. In step 331, the device usage and output determination server 110 may cause the notification to be displayed on the device 150 (e.g., on a display of the device).

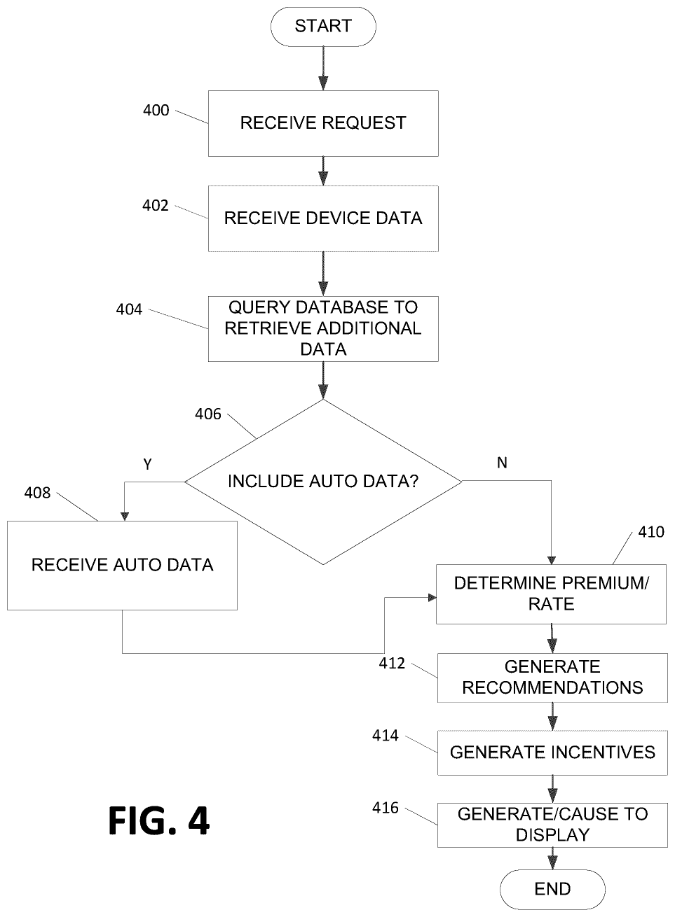

FIG. 4 illustrates one example process for evaluating device usage to determine an output, such as an insurance premium, according to one or more aspects described herein. The steps described with respect to FIG. 4 may be performed by one or more of the various devices described herein, such as the device usage and output determination server 110, vehicle data analysis server 140, user personal mobile device 150, and the like.

In step 400, a request may be received. In some examples, the request may include a request to insure a device, such as user personal mobile device 150. In some examples, the request may include registration information, such as a name and contact information of a user, type of device, make and model of the device, unique identifier associated with the device, and the like.

In step 402, device data may be received. As discussed herein, device data may be received from a variety of sources and may include data such as amount of usage, type of usage, applications executing on the device, type of applications executing on the device, location of the device, and the like. The data may be received from various sources, such as one or more sensors within the device, GPS systems within the device, usage monitors associated with the device, and the like.

In step 404, a database may be queried to obtain additional information about the device and/or device user. For instance, information supplied during a registration process may be stored in one or more databases and those databases may be queried to retrieve information such as a type of device, make and model of the device, and the like. In some examples, the same or different database may be queried to obtain additional information about the user of the device. For instance, data such as age of the user, gender of the user, history of the user, and the like, may be retrieved.

In step 406, a determination may be made as to whether automobile and/or driving data may be included in determining the output. If so, vehicle operation and/or driving behavior data may be received in step 408 (e.g., from vehicle data analysis server 140).

In step 410, an output may be determined. For instance, an insurance premium or rate may be determined based on the received device data, additional data from the database, and/or vehicle data. The premium may be fixed for a particular term (e.g., six months, one year, etc.).

In step 412, the received data may be evaluated to identify one or more recommendations for reducing a risk of damage to the device. In step 414, one or more incentives to implement the recommendations may be generated and, in step 416, the recommendations and/or incentives may be displayed on a user interface generated by the server 110 and caused to be displayed on the user personal mobile device 150.

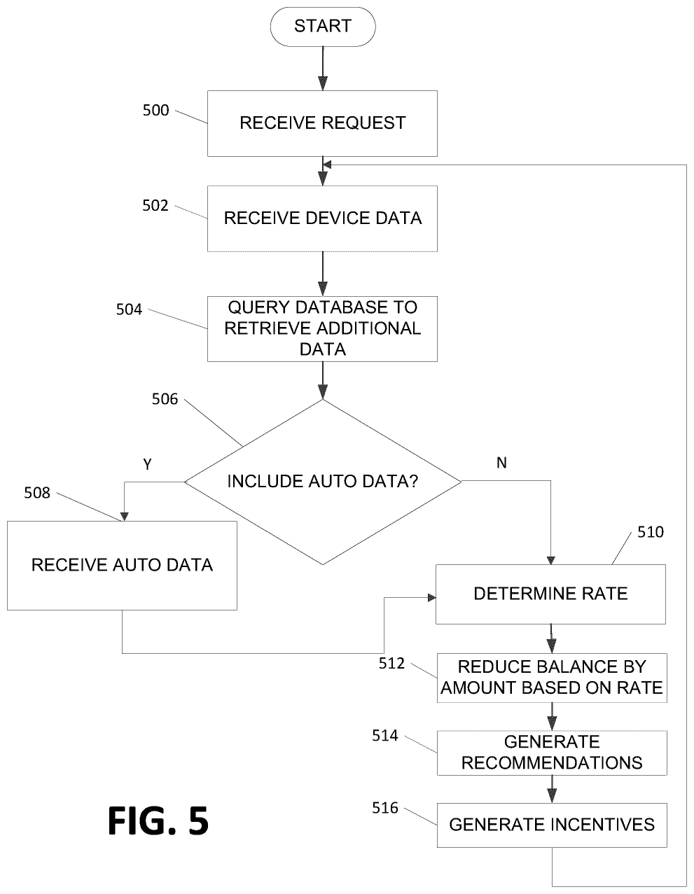

FIG. 5 is one example flow chart illustrating a process for generating a premium for a usage-based insurance arrangement according to one or more aspects described herein. The steps described with respect to FIG. 5 may be performed by one or more of the various devices described herein, such as the device usage and output determination server 110, vehicle data analysis server 140, user personal mobile device 150, and the like.

In step 500, similar to step 400 in FIG. 4, a request may be received. In some examples, the request may include a request to insure a device, such as user personal mobile device 150. In some examples, the request may include registration information, such as a name and contact information of a user, type of device, make and model of the device, unique identifier associated with the device, and the like.

In step 502, device data may be received. As discussed herein, device data may be received from a variety of sources and may include data such as amount of usage, type of usage, applications executing on the device, type of applications executing on the device, location of the device, and the like. The data may be received from various sources, such as one or more sensors within the device, GPS systems within the device, usage monitors associated with the device, and the like.

In step 504, a database may be queried to obtain additional information about the device. For instance, information supplied during a registration process may be stored in one or more databases and those databases may be queried to retrieve information such as a type of device, make and model of the device, age of user, gender of the user, history of user, and the like.

In step 506, a determination may be made as to whether automobile and/or driving data may be included in determining the output. If so, vehicle operation and/or driving behavior data may be received in step 508 (e.g., from vehicle data analysis server 140).

In step 510, a rate may be determined by the system. In some examples, the rate may be a variable rate at which an account balance should be reduced based on usage of the device (e.g., $X.XX dollars for everyone 1 hour of use, one day of use, or the like). The rate may be based on a risk determined based on the data received and analyzed, as discussed herein. The variable rate may be dynamically modified based on real-time data received and analyzed.

In step 512, a balance of an account may be reduced by an amount associated with the rate and usage for a period of time. For instance, if the rate is $X.XX per one day of use, at the end of each day, a balance of an account may be reduced by $X.XX. In another example, if the rate is $.YY per hour, the number of hours of use may be multiplied by $.YY to determine an amount to be deducted from a balance. This calculation may be performed daily, weekly, monthly, or the like.

In step 514, one or more recommendations may be generated. In step 516, one or more incentives to implement the recommendations may be generated and the recommendations and/or incentives may be displayed on the user personal mobile device 150. The process may then return to step 502 in which data is received. The process may continue and a new rate may be determined based on risk associated with the newly received data. This processed may be performed continuously, once per day, once per week, once per month, or the like.

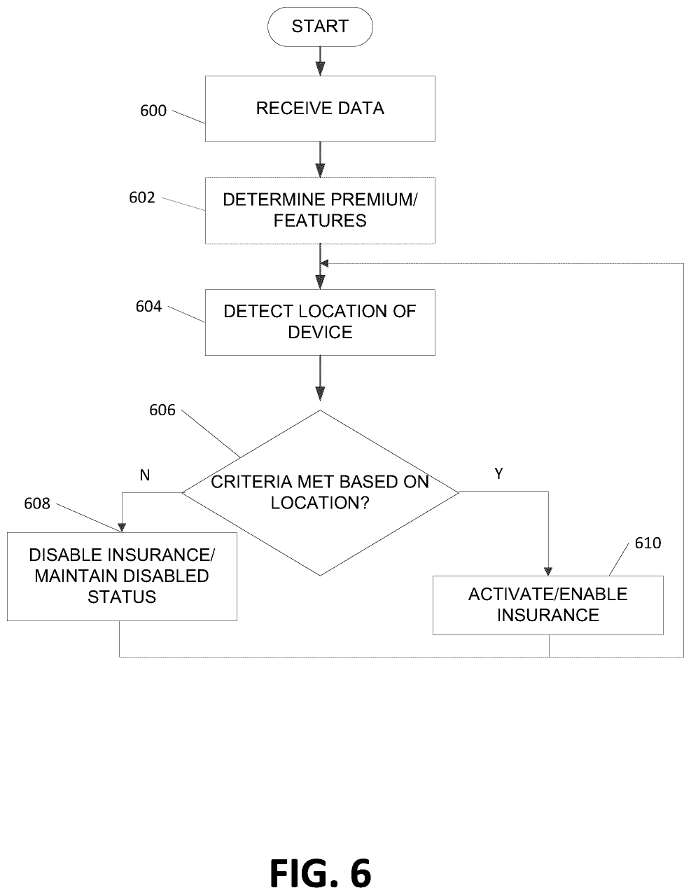

FIG. 6 is a flow chart illustrating one example process for activating or enabling insurance on a user personal mobile device 150 according to one or more aspects described herein. One or more steps may be performed by one or more of the various devices described herein.

In step 600, data may be received and analyzed. The data may include data from a variety of sources and may include data associated with device usage, vehicle data, and/or other additional data, as discussed more fully herein.

In step 602, the received data may be used to determine a premium or rate for insuring the user personal mobile device 150. In some examples, this determination may also include one or more features or characteristics of an insurance policy associated with the device. For instance, a user may request to insure a device only in certain circumstances (e.g., when near water, when out of the country, when outside a designated geo-fence around a particular location, or the like). Such arrangements may permit a user to pay a lower cost for a premium because the device would only be insured (e.g., damage would only be covered) if the designated criteria is met (e.g., near water, out of the country, etc.).

In step 604, a current location of the user personal mobile device insured under the policy having a premium and/or features determined in step 602 may be determined. The current location may be based on GPS information received from the device, from geo-tagged location information embedded in or associated with other data, images or the like received from the device, and the like.

In step 606, a determination may be made as to whether one or more criteria for enabling insurance has been met. For instance, the system may determine whether the determined current location is within a predefined proximity of a comparison location. For instance, if a feature of the policy is that insurance is enabled upon the device being out of a home country of the user, if the currently location determined is outside the known boundaries of the home country, the criteria may be considered met and, in step 610, insurance coverage may be automatically enabled by the system. If the current location is determined to be within the known boundaries of the home country, insurance coverage may be disabled or the disabled status of insurance coverage may be maintained.

In another example, if, in step 606, the current location in step 604 is determined to be within a predefined proximity of a body of water (e.g., within 50 feet, 10 feet, etc. of a lake, pond, ocean, or the like), the criteria may be considered met and, in step 610 insurance coverage may be enabled or activated. If not, insurance coverage may be disabled or a disabled status may be maintained.

The system may then return to step 604 to determine a current location of the device. The location may be determined continuously or once per hour, day, week, or the like. In some examples, once insurance coverage has been activated or enabled, it may remain in an activated state (e.g., insurance coverage may be in effect for the device) until the a current location is determined that does not meet the criteria. At that point, the system may disable or deactivate the insurance coverage.

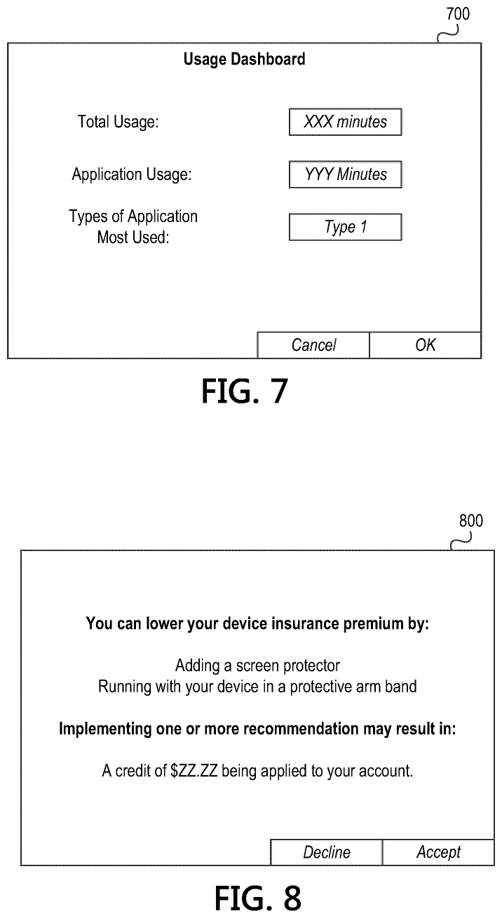

FIGS. 7 and 8 are example user interfaces that may be generated by and/or displayed by one or more devices described herein. For instance, FIG. 7 illustrates a user interface 700 including information related to usage of the device being insured or for which insurance is being requested. The interface 700 may include information such as total amount of usage (e.g., hours, minutes, or the like), amount of application usage, types of applications used, and the like. In some examples, the dashboard 700 may be generated on a periodic basis (e.g., weekly, monthly, or the like) and the device usage and output determination server 110 may cause the interface 700 to be displayed on the user personal mobile device 150. In other examples, the dashboard shown in interface 700 may be generated on an on-demand basis to provide information to a user.

The information shown in user interface 700 are merely some examples of information that may be provided via the dashboard. Various other types of information may be displayed on the interface 700 without departing from the invention. For instance, one or more other reports may be generated and displayed to a user (e.g., on a display of user personal mobile computing device 150). Some additional example reports may include reports to parents of usage of a device associated with a child or other family member (e.g., when multiple devices are linked in an account), reports regarding security protocols of applications that have been downloaded to the device 150 or are executing on the device 150, reports related to hacking of one or more applications on the device 150, reports regarding safe use of device 150 (e.g., whether in use while the user is driving, whether one or more applications or functions are disabled while driving, etc.), and/or reported related to whether malware is present on the device 150.

FIG. 8 illustrates one user interface 800 that may include one or more recommendations generated for a user to reduce risk associated with device usage, as well as one or more incentives to implement the one or more recommendations. Various other recommendations and/or incentives may be provided without departing from the invention.

FIG. 9 illustrates a block diagram of a computing device (or system) 901 in a computer system 900 that may be used according to one or more illustrative embodiments of the disclosure. The device 901 may have a processor 903 for controlling overall operation of the device 901 and its associated components, including RAM 905, ROM 907, input/output module 909, and memory 915. The computing device 901, along with one or more additional devices (e.g., terminals 950 and 951, security and integration hardware 960) may correspond to any of multiple systems or devices, such as a user personal mobile computing device, a vehicle-based computing system, or a computer server, configured as described herein for evaluating device usage, determining one or more outputs, generating one or more recommendations, generating one or more incentives, determining whether one or more recommendations have been implemented, and the like.

Input/Output (I/O) 909 may include a microphone, keypad, touch screen, and/or stylus through which a user of the computing device 901 may provide input, and may also include one or more of a speaker for providing audio output and a video display device for providing textual, audiovisual and/or graphical output. Software may be stored within memory 915 and/or storage to provide instructions to processor 903 for enabling device 901 to perform various actions. For example, memory 915 may store software used by the device 901, such as an operating system 917, application programs 919, and an associated internal database 921. The various hardware memory units in memory 915 may include volatile and nonvolatile, removable and non-removable media implemented in any method or technology for storage of information such as computer readable instructions, data structures, program modules or other data. Certain devices/systems within device usage and output determination system may have minimum hardware requirements in order to support sufficient storage capacity, analysis capacity, network communication, etc. For instance, in some embodiments, one or more nonvolatile hardware memory units having a minimum size (e.g., at least 1 gigabyte (GB), 2 GB, 5 GB, etc.), and/or one or more volatile hardware memory units having a minimum size (e.g., 256 megabytes (MB), 512 MB, 1 GB, etc.) may be used in a device 901 (e.g., a mobile computing device 901, vehicle-based computing system 901, device usage and output determination server 901, external server 901, etc.), in order to store and execute device usage and output determination software application, collect and analyze usage data, generate outputs, generate recommendations and/or incentives, etc. Memory 915 also may include one or more physical persistent memory devices and/or one or more non-persistent memory devices. Memory 915 may include, but is not limited to, random access memory (RAM) 905, read only memory (ROM) 907, electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by processor 903.

Processor 903 may include a single central processing unit (CPU), which may be a single-core or multi-core processor (e.g., dual-core, quad-core, etc.), or may include multiple CPUs. Processor(s) 903 may have various bit sizes (e.g., 16-bit, 32-bit, 64-bit, 96-bit, 128-bit, etc.) and various processor speeds (ranging from 100 MHz to 5 Ghz or faster). Processor(s) 903 and its associated components may allow the system 901 to execute a series of computer-readable instructions, for example, to execute a device usage and output determination software application that receives and processes usage data, generates one or more outputs, generates recommendations and/or incentives, and the like.

The computing device (e.g., a mobile computing device, a vehicle-based device, external server, etc.) may operate in a networked environment 900 supporting connections to one or more remote computers, such as terminals 950 and 951. The terminals 950 and 951 may be personal computers, servers (e.g., web servers, database servers), or mobile communication devices (e.g., mobile phones, portable computing devices, on-board vehicle-based computing systems, and the like), and may include some or all of the elements described above with respect to the computing device 901. The network connections depicted in FIG. 9 include a local area network (LAN) 925 and a wide area network (WAN) 929, and a wireless telecommunications network 933, but may also include other networks. When used in a LAN networking environment, the computing device 901 may be connected to the LAN 925 through a network interface or adapter 923. When used in a WAN networking environment, the device 901 may include a modem 927 or other means for establishing communications over the WAN 929, such as network 931 (e.g., the Internet). When used in a wireless telecommunications network 933, the device 901 may include one or more transceivers, digital signal processors, and additional circuitry and software for communicating with wireless computing devices 940 (e.g., mobile phones, portable computing devices, on-board vehicle-based computing systems, etc.) via one or more network devices 935 (e.g., base transceiver stations) in the wireless network 933.

Also illustrated in FIG. 9 is a security and integration layer 960, through which communications may be sent and managed between the device 901 (e.g., a user's personal mobile device, a vehicle-based system, a device usage and output determination server or other external server, etc.) and the remote devices (950 and 951) and remote networks (925, 929, and 933). The security and integration layer 960 may comprise one or more separate computing devices, such as web servers, authentication servers, and/or various networking components (e.g., firewalls, routers, gateways, load balancers, etc.), having some or all of the elements described above with respect to the computing device 901. As an example, a security and integration layer 960 of a mobile computing device, vehicle-based device, or a server operated by an insurance provider, financial institution, governmental entity, or other organization, may comprise a set of web application servers configured to use secure protocols and to insulate the server 901 from external devices 950 and 951. In some cases, the security and integration layer 960 may correspond to a set of dedicated hardware and/or software operating at the same physical location and under the control of same entities as driving data analysis server 901. For example, layer 960 may correspond to one or more dedicated web servers and network hardware in an organizational datacenter or in a cloud infrastructure supporting a cloud-based driving data analysis system. In other examples, the security and integration layer 960 may correspond to separate hardware and software components which may be operated at a separate physical location and/or by a separate entity.

As discussed below, the data transferred to and from various devices in the computing system 900 may include secure and sensitive data, such as device usage data, application usage data, application type data, and the like. Therefore, it may be desirable to protect transmissions of such data by using secure network protocols and encryption, and also to protect the integrity of the data when stored on in a database or other storage in a mobile device, vehicle data analysis server, or device usage and output determination server and other computing devices in the system 900, by using the security and integration layer 960 to authenticate users and restrict access to unknown or unauthorized users. In various implementations, security and integration layer 960 may provide, for example, a file-based integration scheme or a service-based integration scheme for transmitting data between the various devices in a system 900. Data may be transmitted through the security and integration layer 960, using various network communication protocols. Secure data transmission protocols and/or encryption may be used in file transfers to protect to integrity of the driving data, for example, File Transfer Protocol (FTP), Secure File Transfer Protocol (SFTP), and/or Pretty Good Privacy (PGP) encryption. In other examples, one or more web services may be implemented within the various devices 901 in the system 900 and/or the security and integration layer 960. The web services may be accessed by authorized external devices and users to support input, extraction, and manipulation of the data (e.g., device usage data, location data, vehicle data, etc.) between the various devices 901 in the system 900. Web services built to support system 900 may be cross-domain and/or cross-platform, and may be built for enterprise use. Such web services may be developed in accordance with various web service standards, such as the Web Service Interoperability (WS-I) guidelines. In some examples, a movement data and/or driving data web service may be implemented in the security and integration layer 960 using the Secure Sockets Layer (SSL) or Transport Layer Security (TLS) protocol to provide secure connections between servers 901 and various clients 950 and 951 (e.g., mobile devices, data analysis servers, etc.). SSL or TLS may use HTTP or HTTPS to provide authentication and confidentiality. In other examples, such web services may be implemented using the WS-Security standard, which provides for secure SOAP messages using XML encryption. In still other examples, the security and integration layer 960 may include specialized hardware for providing secure web services. For example, secure network appliances in the security and integration layer 960 may include built-in features such as hardware-accelerated SSL and HTTPS, WS-Security, and firewalls. Such specialized hardware may be installed and configured in the security and integration layer 960 in front of the web servers, so that any external devices may communicate directly with the specialized hardware.

Although not shown in FIG. 9, various elements within memory 915 or other components in system 900, may include one or more caches, for example, CPU caches used by the processing unit 903, page caches used by the operating system 917, disk caches of a hard drive, and/or database caches used to cache content from database 921. For embodiments including a CPU cache, the CPU cache may be used by one or more processors in the processing unit 903 to reduce memory latency and access time. In such examples, a processor 903 may retrieve data from or write data to the CPU cache rather than reading/writing to memory 915, which may improve the speed of these operations. In some examples, a database cache may be created in which certain data from a database 921 (e.g., a device usage database, a vehicle data database, location database, etc.) is cached in a separate smaller database on an application server separate from the database server. For instance, in a multi-tiered application, a database cache on an application server can reduce data retrieval and data manipulation time by not needing to communicate over a network with a back-end database server. These types of caches and others may be included in various embodiments, and may provide potential advantages in certain implementations of retrieving device usage data, vehicle data, and individual data, such as faster response times and less dependence on network conditions when transmitting/receiving device usage and output determination software applications (or application updates), usage data, vehicle data, etc.

It will be appreciated that the network connections shown are illustrative and other means of establishing a communications link between the computers may be used. The existence of any of various network protocols such as TCP/IP, Ethernet, FTP, HTTP and the like, and of various wireless communication technologies such as GSM, CDMA, WiFi, and WiMAX, is presumed, and the various computer devices and system components described herein may be configured to communicate using any of these network protocols or technologies.

Additionally, one or more application programs 919 may be used by the various computing devices 901 within a device usage and output determination system 900 (e.g., device usage and output determination software applications, etc.), including computer executable instructions for receiving and storing device usage data, vehicle data, analyzing data, determining outputs, generating recommendations, generating incentives, and performing other related functions as described herein.

As discussed herein, various examples for customizing an insurance policy and/or premium based on usage of a device are described. In some examples, the insurance may cover theft, damage, breakage, and the like. The system may generate one or more levels of coverage depending on a desired level of protection. For instance, cost to only insure the device 150 against theft may have a lower premium than coverage for theft, breakage, etc.

In some examples, a level of coverage may control a type or amount of data transmitted from the device 150, vehicle 260, or other source. For instance, in arrangements in which the device is only insured for theft, some types of data may be less relevant to determining the premium. For instance, data associated with application usage might not be used when determining the premium. Accordingly, the device usage and output determination server may control an amount or type of data collected by the device usage monitor 255 (e.g., may transmit a signal to the device usage monitor 255 instructing the device 255 to collect only certain types of data or amounts of data). Accordingly, the device usage and output determination server 110 may control a type of amount of data received, processed, etc., thereby controlling the computing resources needed to process the data, determine one or more outputs, and the like.

Further, in some examples, a baseline cost may be established for a particular user personal mobile computing device 150 and the usage data may be analyzed to adjust the baseline cost. For instance, the system may generate a baseline level of risk associated with a particular device (e.g., based on type of device, device breakage testing results, etc.). This may form a baseline for cost associated with insuring the device 150 and may be associated with a baseline insurance premium. The various types of data described herein may then be analyzed to determine whether an adjustment to the baseline premium should be made based on an increased likelihood of damage (or an increase over a predetermined threshold amount for which the baseline value might not be adjusted). If the analysis of usage data (and other data as desired) indicates an increase in likelihood of damage over a certain threshold, the premium may be increased.

In some examples, the arrangements described herein may also be provided as part of a bundle of insurance products. For instance, a user having automobile insurance with an insurance provided may be invited to obtain personal mobile device insurance at, for instance, a discounted premium because they are an existing customer. In another example, a user having both home and automobile insurance with an insurance provider may be invited to obtain personal mobile device insurance for little or no cost for a predetermined term (e.g., three months, six months, one year, etc.) as an incentive to consider purchasing the insurance.

Some example arrangements described herein may further permit a user to make a claim without having a policy in place covering damage to the user personal mobile computing device 150. For instance, a user who does not have insurance on a device 150 may suffer damage to the device, such as a cracked screen. The user may then contact the insurance provider who may cover a cost to repair the screen if a user then signs up for a policy. Accordingly, in these arrangements, even damage suffered while the device was not covered by insurance may be covered upon purchasing a policy.

The usage data collected by the devices and systems described herein may be obtained with the permission of the user associated with the device and, in some examples, the user may be given the option to share an anonymized version of his or her data with one or more entities. If the user approves sharing an anonymized version of the data, a discount or the like may be applied toward a premium of the user.

Usage data collected by the devices and/or systems may also be used to customize blocking of one or more applications. For instance, if a particular application or type of application is used more than is desirable, that particular application may be blocked or uninstalled on the device.

In some examples, the system may detect multiple different users of a device and may determine a likelihood of damage based on each user's usage of the device. For instance, a fingerprint, voice print, pattern of finger or thumb movement, or the like may be used to distinguish between different users of a device (e.g., a parent and child, siblings, husband and wife, etc.). Accordingly, usage data for each user may be evaluated to determine a likelihood of damage associated with each user, which then may be used to determine an overall likelihood of damage and/or premium.

While the aspects described herein have been discussed with respect to specific examples including various modes of carrying out aspects of the disclosure, those skilled in the art will appreciate that there are numerous variations and permutations of the above described systems and techniques that fall within the spirit and scope of the invention.

1. A system comprising:
a sensor data processing system configured to obtain data from one or more sensors of a mobile computing device, the sensor data processing system identifying a type of movement of the mobile computing device using the data;
an application evaluation system determining a category of one or more applications based on an amount of time corresponding to an interaction with the one or more applications executing on the mobile computing device;
a geographic location system determining a location of the mobile computing device using location data received from the mobile computing device; and
an output determination system causing the mobile computing device to perform one or more actions based on at least one of the type of movement, the category of the one or more applications, the amount of time spent interacting with the one or more applications, or the location.

2. The system of claim 1, wherein the data is obtained using at least one of an accelerometer, a gyroscope, a pressure sensor, or a proximity sensor of the mobile computing device.

3. The system of claim 1, wherein a portion of the data below a threshold of movement is filtered before processing by the sensor data processing system.

4. The system of claim 1, wherein the one or more actions include at least one of block or uninstall the one or more applications from executing on the mobile computing device based on at least one of the type of movement, the category of the one or more applications, the amount of time spent interacting with the one or more applications, or the location.

5. The system of claim 1, further comprising:
a recommendation system generating one or more recommendations to reduce potential damage to the mobile computing device based on at least one of the type of movement, the category of the one or more applications, the amount of time spent interacting with the one or more applications, or the location,
wherein the one or more actions include presenting the one or more recommendations on a display of the mobile computing device.

6. The system of claim 1, wherein the one or more actions include a presentation of usage information associated with the mobile computing device based on at least one of the type of movement, the category of the one or more applications, the amount of time spent interacting with the one or more applications, or the location.

7. The system of claim 1, wherein the type of movement is identified by processing the data to identify a signature of one or more signals of the data associated with the type of movement.

8. A method comprising:
obtaining data from one or more sensors arranged of a mobile computing device;
identifying a type of movement of the mobile computing device using the data;
determining an amount of time spent interacting with one or more applications executing on the mobile computing device;
determining a category of the one or more applications;
receiving location data from the mobile computing device;
determining a location of the mobile computing device using the location data; and
generating one or more instructions to cause the mobile computing device to perform one or more actions based on at least one of the type of movement, the category of the one or more applications, the amount of time spent interacting with the one or more applications, or the location.

9. The method of claim 8, wherein the data is collected by at least one of an accelerometer, a gyroscope, a pressure sensor, or a proximity sensor of the mobile computing device.

10. The method of claim 8, wherein a portion of the data that is below a threshold of movement is filtered.

11. The method of claim 8, wherein the one or more actions include at least one of block or uninstall the one or more applications from executing on the mobile computing device based on at least one of the type of movement, the category of the one or more applications, the amount of time spent interacting with the one or more applications, or the location.

12. The method of claim 8, further comprising:
generating one or more recommendations to reduce potential damage to the mobile computing device based on at least one of the type of movement, the category of the one or more applications, the amount of time spent interacting with the one or more applications, or the location,
wherein the one or more actions include presenting the one or more recommendations on a display of the mobile computing device.

13. The method of claim 8, wherein the one or more actions include a presentation of usage information associated with the mobile computing device based on at least one of the type of movement, the category of the one or more applications, the amount of time spent interacting with the one or more applications, or the location.

14. The method of claim 8, wherein the type of movement is identified by processing the data to identify a signature of one or more signals of the data associated with the type of movement.

15. One or more non-transitory, computer-readable media storing instructions that, when executed by at least one processor, cause the at least one processor to:
determine a type of movement using data obtained using one or more sensors associated with a mobile computing device;
determine an amount of time spent interacting with one or more applications executing on the mobile computing device;
determine a category of the one or more applications;
determine a location of the mobile computing device using location data obtained by the mobile computing device; and
generate one or more instructions to cause the mobile computing device to perform one or more actions based on at least one of the type of movement, the category of the one or more applications, the amount of time spent interacting with the one or more applications, or the location.

16. The one or more non-transitory, computer-readable media of claim 15, wherein the data is collected by at least one of an accelerometer, a gyroscope, a pressure sensor, or a proximity sensor of the mobile computing device.

17. The one or more non-transitory, computer-readable media of claim 15, wherein a portion of the data that is below a threshold of movement is filtered.

18. The one or more non-transitory, computer-readable media of claim 15, wherein the one or more actions include at least one of block or uninstall the one or more applications from executing on the mobile computing device based on at least one of the type of movement, the category of the one or more applications, the amount of time spent interacting with the one or more applications, or the location.

19. The one or more non-transitory, computer-readable media of claim 15, storing further instructions that, when executed by the at least one processor, further cause the at least one processor to:
generate one or more recommendations to reduce potential damage to the mobile computing device based on at least one of the type of movement, the category of the one or more applications, the amount of time spent interacting with the one or more applications, or the location,
wherein the one or more actions include presenting the one or more recommendations on a display of the mobile computing device.

20. The one or more non-transitory, computer-readable media of claim 15, wherein the one or more actions include a presentation of usage information associated with the mobile computing device based on at least one of the type of movement, the category of the one or more applications, the amount of time spent interacting with the one or more applications, or the location.
